(19) United States
(12) Patent Application Publication
(10) Pub. No.: US 2015/0170260 A1
(43) Pub. Date: Jun. 18, 2015

(54) Methods and Systems for Using a Mobile Device to Visualize a Three-Dimensional Physical Object Placed Within a Three-Dimensional Environment

(71) Applicants: Jennifer LEES, San Jose, CA (US); Jonathan HUANG, Santa Clara, CA (US)

(72) Inventors: Jennifer LEES, San Jose, CA (US); Jonathan HUANG, Santa Clara, CA (US)

(73) Assignee: Google Inc., Mountain View, CA (US)

(21) Appl. No.: 13/408,454

(22) Filed: Feb. 29, 2012

(51) Int. Cl. G06Q 30/06; G06T 15/20; G06K 9/46; G06F 3/01; G06T 19/00; G06T 17/00

(52) U.S. Cl. CPC G06Q 30/0643; G06T 19/006; G06T 17/00; G06K 9/46; G06F 3/017; G06T 15/20

(57) ABSTRACT

Systems, methods and computer program products for using a mobile device to visualize physical objects in an environment are described herein. An embodiment includes receiving a three-dimensional model of an environment, detecting, using a sensor on the mobile device, an identifier identifying a physical object and retrieving, using the detected identifier, a three-dimensional model of the physical object. An embodiment further includes displaying, on the mobile device, the three-dimensional model of the physical object within the three-dimensional model of the environment and, in response to user gestures on the mobile device, displaying the physical object at different places within the environment.

### BACKGROUND

1. Field

Embodiments generally relate to using a mobile device to visualize a three-dimensional physical object within a three-dimensional environment.

2. Background

When shopping for furniture, individuals like to visualize the furniture placed in the actual room before buying it. Software applications with various levels of capability are available to create such visualizations.

Applications for mobile devices are available to create two-dimensional visualizations. For example, an application stitches a series of adjacent photographs of a room into a two dimensional panorama and allows a user to place another image, for example of furniture, at any location on the panorama. As another example, an application allows users to superimpose images, for example of furniture, on the camera's current view, which can be a view of room. The applications can provide a catalogue of representative pieces of furniture for display on the panorama. The restriction to two dimensions, of course, provides an incomplete visualization.

Applications are available, online or for desktop or laptop computers, that can be used to create three-dimensional models. Some applications make it possible for users to create a detailed three-dimensional model of a room. For example, one application accepts a floor plan and provides three-dimensional models of cupboards, counters, doors, window and so on that can be added to the floor plan or walls and creates a three-dimensional model of a room. The software also typically has a catalog of three-dimensional models for pieces of furniture that can be added to the room to visualize how the furniture appears. Although available furniture might be similar to items the user is interested in, the exact item might not be available.

The available applications help users visualize furniture in a room to various degrees and with some shortcomings. Some provide only two-dimensional models. The three-dimensional models might only resemble the actual room and the user might not be able to display a three-dimensional model of the actual furniture item of interest. Finally, the applications do not provide a convenient way to visualize at the point of sale a three-dimensional model of the exact piece of furniture in a three-dimensional model of the exact room.

### BRIEF SUMMARY

Systems, methods and computer program products for using a mobile device to visualize three-dimensional physical objects within a three-dimensional environment are described herein. An embodiment includes receiving a three-dimensional model of an environment, using a sensor on the mobile device to detect an identifier that identifies a physical object and using the detected identifier to retrieve a three-dimensional model of the physical object. An embodiment further includes displaying, on the mobile device, the three-dimensional model of the physical object within the three-dimensional model of the environment and, in response to user gestures on the mobile device, displaying the physical object at different places within the environment.

Further embodiments optionally include using the mobile device to create a three-dimensional model of the environment, which can be a room. The user measures and inputs the length and width of the room and is then prompted to take a series of overlapping photographs while standing at the exact center of the environment. The photographs are taken starting at zero degrees (straight ahead) and rotating in a 360-degree circle to capture the entire room. A three-dimensional model of the environment is created based on the measurements and photographs.

The mobile device can be used while shopping for a piece of furniture to visualize how the piece of furniture would look in the room. Before shopping, the user takes a series of Photographs of the room, as described above, and a three-dimensional model of the room created and available to be displayed on the mobile device. At the showroom, if the user is interested in a piece of furniture that has available a three-dimensional physical model, the model can be downloaded by taking a picture of a Quick Response (QR) barcode identifying the piece of furniture. The piece of furniture will appear in and can be placed at different places within the room.

### BRIEF DESCRIPTION OF THE DRAWINGS

Embodiments are described with reference to the accompanying drawings. In the drawings, like reference numbers may indicate identical or functionally similar elements. The drawing in which an element first appears is generally indicated by the left-most digit in the corresponding reference number.

FIG. 1 is a flowchart showing a method for displaying a three-dimensional physical object in a three-dimensional environment.

FIG. 2 is a flowchart that illustrates a method for creating three-dimensional points in space from image data.

FIG. 3 illustrates a mobile device scanning a Quick Response (QR) barcode that identifies a physical object.

FIG. 4 illustrates a three-dimensional physical object displayed within a three-dimensional environment.

FIG. 5 is a system for visualizing a three-dimensional physical object within a three-dimensional environment.

FIG. 6 is a flowchart illustrating an exemplary overall operation for visualizing a three-dimensional physical object within a three-dimensional environment.

FIG. 7 illustrates an example computer useful for implementing components of the embodiments.

### DETAILED DESCRIPTION

While the present invention is described herein with reference to the illustrative embodiments for particular applications, it should be understood that the invention is not limited thereto. Those skilled in the art with access to the teachings provided herein will recognize additional modifications, applications, and embodiments within the scope thereof and additional fields in which the invention would be of significant utility.

In the detailed description of embodiments that follows, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of one skilled in the art to affect such feature, structure, or characteristic in connection with other embodiments whether or not explicitly described.

The embodiments described herein relate generally to viewing a three-dimensional physical object in a three-dimensional environment and can be used when the object and environment are not co-located. An example is when visiting a furniture showroom to be able to view a piece of furniture in the room for which it is being considered.

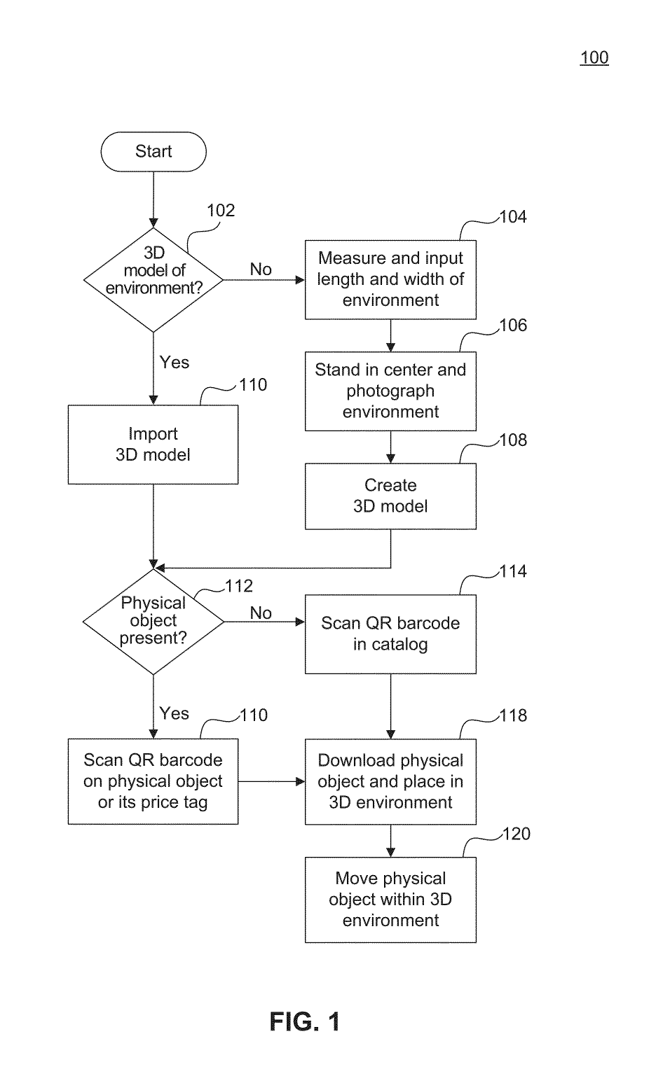

FIG. 1 is a flowchart of the steps for displaying a three-dimensional model of a physical object within a three-dimensional environment. At step 102, it is determined if a 3D model of the environment is available for downloading. If a 3D model is not available, the mobile device creates it. At step 104, the user measures the length and width of the room and enters the measurements into the mobile device. Next, at step 106, the user stands in the center of the room and, prompted by the mobile device, takes a series of photographs starting at zero degrees and rotating in a 360 degree circle to photograph the entire environment.

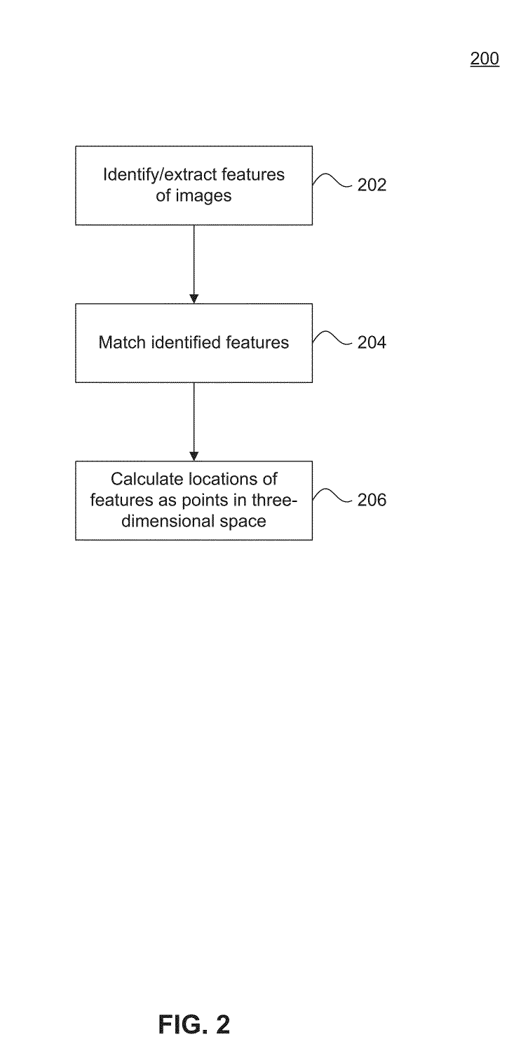

At step 108, the mobile device creates a three-dimensional model of the room based on the series of images collected in step 106. The images are a panorama of overlapping photographs covering the entire room and form the basis for creating the three-dimensional model. FIG. 2 is a flowchart that demonstrates a method 200 for creating three-dimensional points in space from image data. Method 200 starts with step 202.

At step 202 features are identified/extracted. Extracting features may include interest point detection and feature detection. Interest point detection detects points in an image according a condition. The neighborhood of each interest point is a feature. Each feature is represented by a descriptor. As an example, the Speeded Up Robust Features (SURF) algorithm can be used to extract features from neighboring images. SURF includes an interest point detection and feature description scheme. Each feature descriptor includes a 128-dimensional vector.

At step 204, identified/extracted features are matched. The similarity between a first feature (in one image) and a second feature (in a second image) may be determined by finding the Euclidean distance between the vector of the first feature and the vector of the second feature.

A match for a feature in the first image among the features in the second image may be determined as follows. First, the nearest neighbor (e.g., in 128-dimensional space) of the feature in the first image is determined from among the features in the second image. Second, the second-nearest neighbor of the feature in the first image is determined from among the features in the second image. Third, a first distance between the feature in the first image and the nearest neighboring feature in the second image, and a second distance between the feature in the first image and the second nearest neighboring feature in the second image are determined. Fourth, a feature similarity ratio is calculated by dividing the first distance by the second distance. If the feature similarity ratio is below a particular threshold, there is a match between the feature in the first image and its nearest neighbor in the second image.

If the feature similarity ratio is too low, enough matches may not be determined. If the feature similarity ratio is too high, too many false matches may be determined. As an example, the feature similarity ratio may be between 0.5 and 0.95 inclusive.

At step 206, the locations of the features are determined as points in three-dimensional space determined by computing stereo triangulations using pairs of matching features. Rays are constructed for each of the features in a matched pair and the point is determined based on the intersection of the rays. For each feature, a ray is constructed from the corresponding camera viewpoint through the corresponding feature. If, due to imprecision, the rays do not actually intersect, a line segment where the rays are closest can be determined and the three-dimensional point used may be the midpoint of the line segment. The calculations for each pair of matched features determine a point cloud of three-dimensional points.

The final steps in creating a three-dimensional model are to apply a surface model to the point cloud and to map a texture to the points. In computer graphics, a triangular mesh is commonly used as a surface model for a point cloud. A triangular mesh comprises a set of triangles that are connected by their common edges or corners. The corners are the points from the point cloud and each point from the point cloud is a corner of one or more triangles. A mesh can be constructed from a point cloud using a process called Delaunay triangulation. Each point is connected by lines to its closest neighbors in a way such that all line parts form triangles and do not intersect and no triangles overlap.

A panorama is formed from the series of photographs taken in step 106 and used as the texture for the model in the following way. Each point in the point cloud represents a feature that, in step 202, was identified/extracted from a photograph and is associated with a particular pixel in the photograph and in the panorama. The location of the pixel in the panorama is mapped to the point. The mapping is done for every point in the mesh. When the three-dimensional model is rendered, the mapped locations are used to identify the appropriate part of the panorama to use for texturing each triangle.

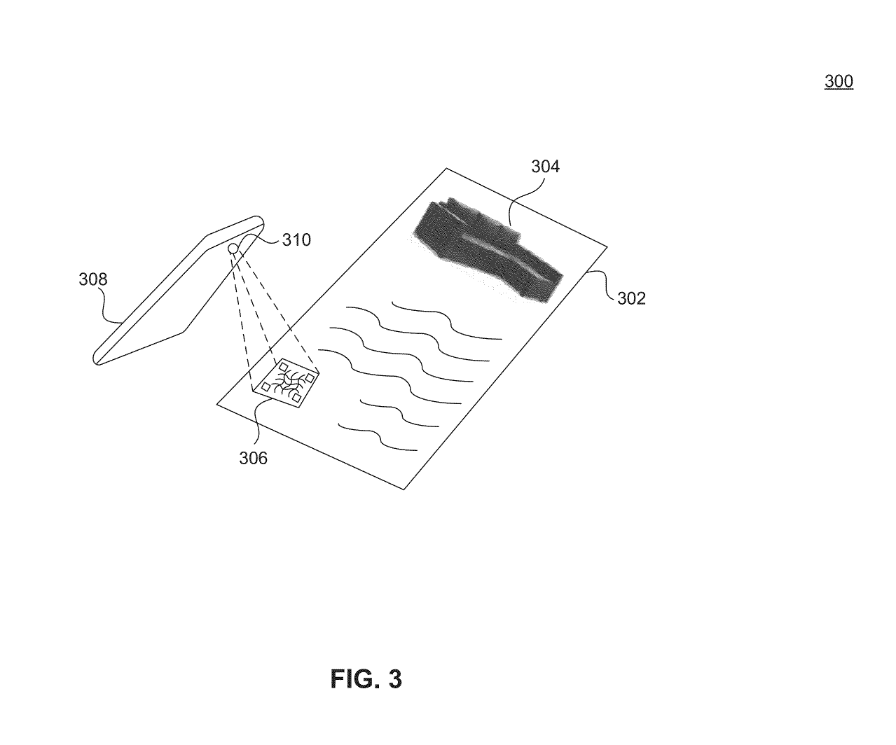

Referring back to FIG. 1, at step 112, the user determines whether or not the physical object (e.g., a piece of furniture), is present or only shown in a catalog. FIG. 3 illustrates how a three-dimensional physical model is obtained in the latter case. A catalog page 302 shows a sofa 304 and a QR barcode 306 that identifies the sofa 304. A QR barcode is a two-dimensional barcode, which can contain a Uniform Resource Locator (URL) and an identifier associated with the physical object. When scanned, for example, by a mobile device, a QR barcode application decodes the URL and identifier.

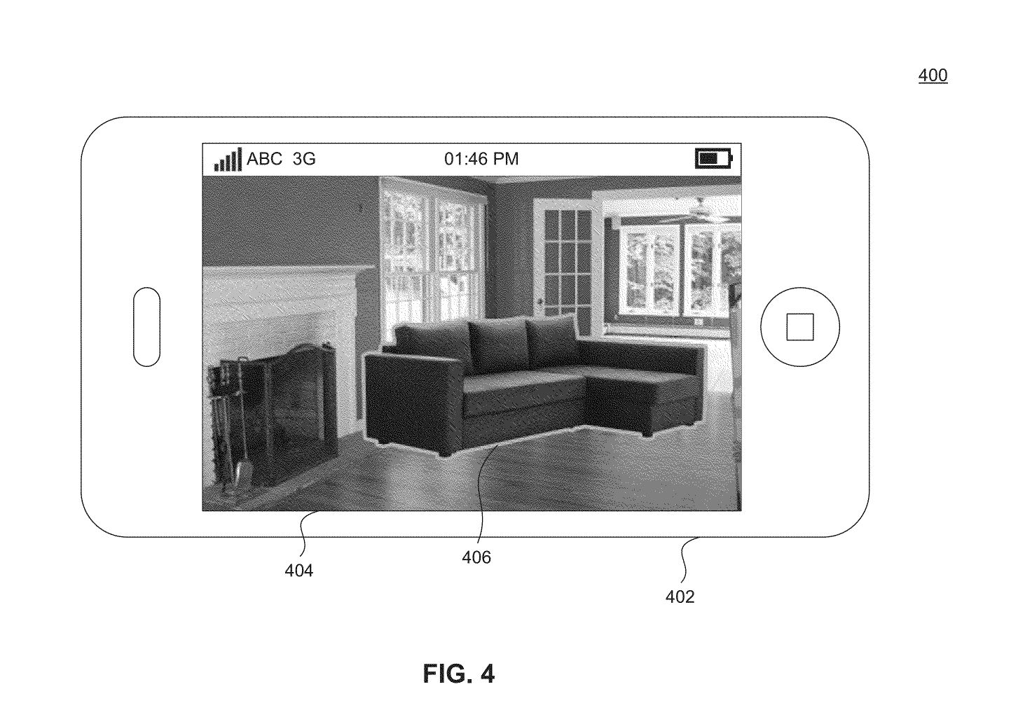

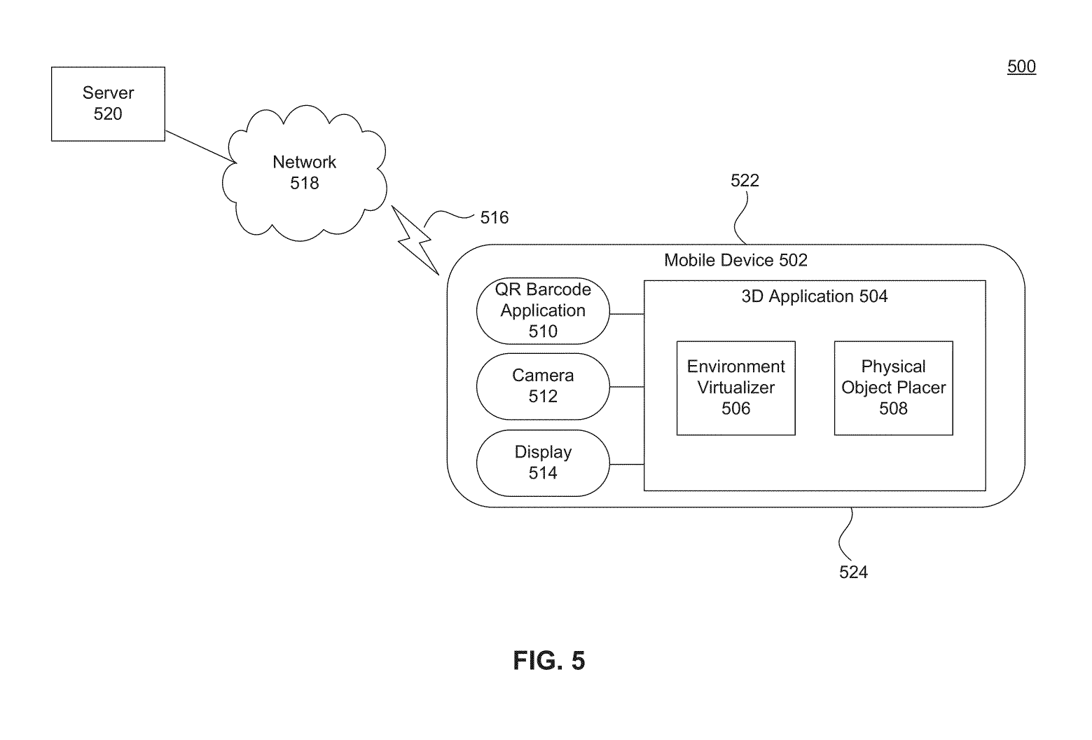

QR barcode 306 contains a Uniform Resource Locator (URL) for a server that has a three-dimensional model for the sofa 304. In an embodiment, a mobile device 308 with a camera 310 is used to take a picture of the QR barcode 306. As described in more detail later (see FIG. 5) applications in the mobile device 308 decode the barcode, use the URL to connect to a server and download the three-dimensional model of the physical object. The model is then placed and displayed in the room. As shown in FIG. 4, mobile device 402 displays the room 404 and the sofa 406 placed within the room.

Referring back to FIG. 1, at step 120, the user can move sofa 406 within the three-dimensional model of the room using various gestures. The user can move the sofa within the room by touching and dragging the sofa on the display or pan the sofa by touching either edge of the mobile device or making horizontal gestures with the mobile device. The user can also change the color of the sofa by touching one of a set of selections on the display.

If there is an existing three-dimensional model at step 102, that model can be imported at step 110. If the room is a more complicated geometry than one that can be characterized with a length and width, the user might use a pre-created three-dimensional model of the room or an application to create the model. When a model of the actual room is imported the user can be prompted to take a series of overlapping photographs of the room. The photographs are then used as a texture map for the three-dimensional model.

Three-dimensional models of physical objects can also be imported. For example, a model of a physical object may be created by scanning the physical object with a three dimensional scanner. The model can be uploaded to a server and a QR barcode can be created that contains an identifier for the model and the URL of the server. The model is downloaded by the mobile device, using the mobile device to scan an image of the QR barcode, which could be displayed, for example, on a computer screen. The downloaded model is placed and can be moved within the three-dimensional environment.

Two-dimensional objects such as paintings can also be imported. The user need only take a photograph of the physical object and provide the dimensions. A three-dimensional model of a rectangular prism is created where the rectangle is the size of the physical object and the thickness of the prism is small relative to the other two dimensions. The photograph is used as a texture map on one side of the prism. The created model is somewhat like a billboard, with the photograph on one side. The three-dimensional model is downloaded and can be placed and moved within the three-dimensional environment as described above.

FIG. 5 shows a system 500 for visualizing a three-dimensional physical object within a three-dimensional environment. System 500 includes mobile device 502, a wireless network 516, a network 518 and a server 520. Server 520 can provide access to content stored locally on server 520 or coupled storage devices (not shown). Network 518 includes one or more networks such as the internet. In some examples, network 518 can include one or more wide area networks or local area networks and one or more network technologies such as Ethernet, Fast Ethernet, Gigabit Ethernet, a variant of IEEE 802.11 such WiFi and the like.

Wireless network 516 includes any wireless network that provides access to network 518. Wireless network 516 includes any wireless networks that provide data transmission, such as 3G, 4G and the like, and WiFi.

Mobile device 502 includes camera 512, display 514, QR barcode application 510 and 3D application 504. 3D application 504 includes environment virtualizer 506 and physical object placer 508. Display 514 is a touchscreen, which in addition to providing a visual display, detects the presence and location of a touch within the display area.

Environment virtualizer 506 receives the length and width measurements entered by the user at step 104 in FIG. 1 and prompts the user to take a series of overlapping photographs at step 106. The prompts include when to start, when adjacent photographs are suitably aligned and have sufficient overlap and when to stop taking photographs. Camera 512 is used at step 104 to photograph the environment. Environment virtualizer 506 receives the images and at, step 108, creates a three-dimensional model of the environment. Environment virtualizer 506 creates the model using the steps described in FIG. 2 and then adds a surface and texture to the model using the images gathered at step 106.

Camera 512 is used to photograph a QR barcode that identifies a physical object. At step 116 the QR barcode is on the physical object. At step 114 the QR barcode is on the page of a catalog that shows the physical object (see FIG. 3). In an embodiment, the QR barcode has the URL for web server 520, which stores a three-dimensional model of the physical object, and the identifier for the physical object.

QR barcode application 510 receives the image of the QR barcode and analyzes it to detect the URL and the identifier for the physical object. Physical object placer 508 uses the URL to establish a connection with server 520 and the identifier for the physical object to request and download a three-dimensional model for the physical object.

Physical object placer 508 places the downloaded three-dimensional model within the three-dimensional environment. Environment virtualizer 506 displays the physical model within the environment on display 514.

In an embodiment, the physical object is displayed at different places within the environment by the user making gestures on the mobile device. In an embodiment, the user can move the physical object within the environment by touching and dragging the physical object on the display 514. The user can pan the physical object by touching side1 522 or side2 524 of the mobile device 502 or making a horizontal gesture in the air with the mobile device 502. The user can also change the color of the physical object by touching one of a set of selections on the display 514.

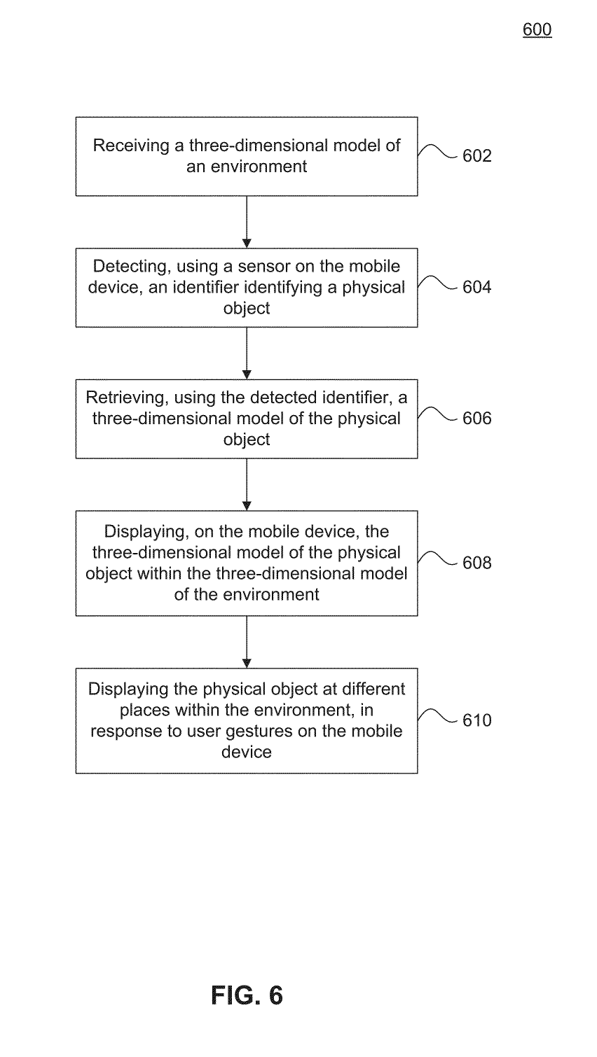

FIG. 6 shows an exemplary overall operation for visualizing a three-dimensional model of a physical object in a three-dimensional environment. Method 600 begins by receiving a three-dimensional model of an environment at step 602. In an embodiment, a user measures and enters the length and width of an environment at step 104 in FIG. 1. The environment visualizer 406 prompts the user to take a series of photographs of the environment at step 106 and, at step 108, uses the measurements and photographs to create a three-dimensional model of the environment.

Method 600 proceeds, at step 604, by detecting, using a sensor on the mobile device, an identifier identifying a physical object. In an embodiment, a user with mobile device 502 uses the camera 514 to photograph a QR barcode which identifies a physical object. The information on QR barcode includes an identifier for the physical object and a URL for server 520 that stores a three-dimensional model of the physical object. The QR barcode application 510 analyzes the photograph to detect the identifier and the URL.

Method 600 proceeds, at step 606, by retrieving, using the detected identifier, a three-dimensional model of the physical object. In an embodiment, physical object placer 508 uses the URL and identifier to download the three-dimensional model of the physical object from server 520.

Method 600 proceeds at step 608 by displaying, on the mobile device, the three dimensional model of the physical object within the three-dimensional model of the environment. In an embodiment, physical object placer 508 places the three-dimensional model of the physical object within the three-dimensional model of the environment and environment virtualizer 506 displays the three-dimensional model of the physical object within the three-dimensional model of the environment. The rendered image is displayed on mobile device 402 as shown in FIG. 4. In FIG. 4, the environment is room 404 and the physical object is sofa 406.

Method 600 ends at step 606 by displaying the physical object at different places within the environment by responding to user gestures. In an embodiment, the user can move the physical object by touching or dragging it on display 514. The user can pan the physical object by touching side1 522 or side2 524 of mobile device 502 or by making a horizontal gesture in the air with mobile device 502.

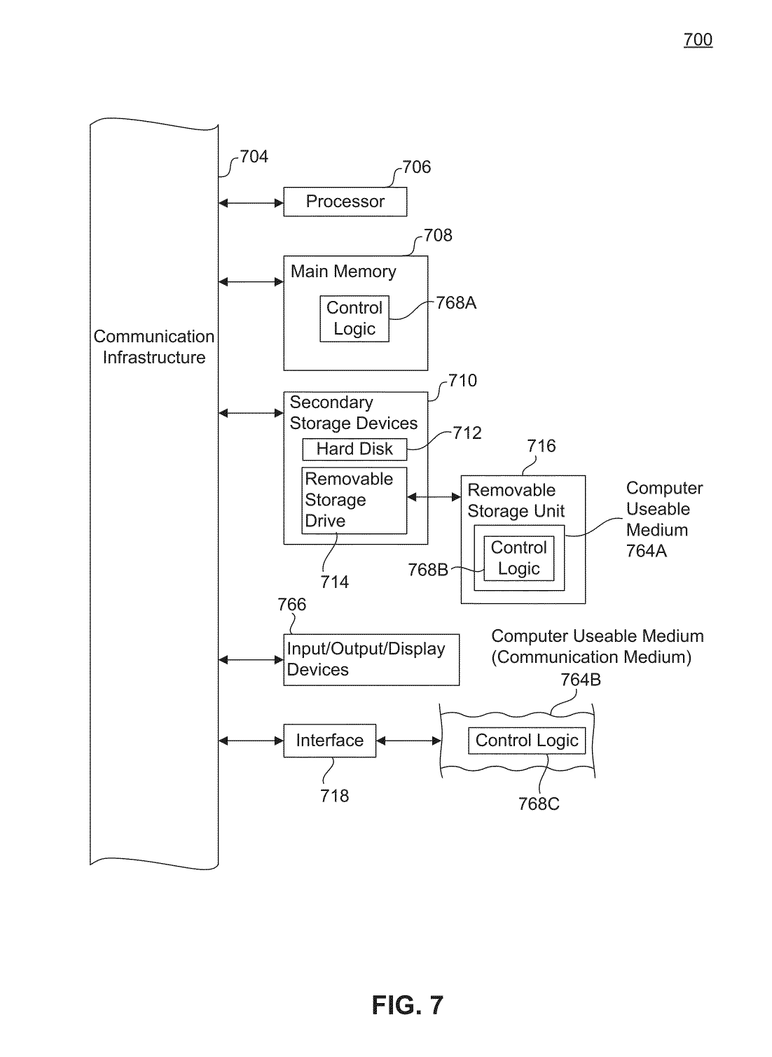

In an embodiment, the system, methods and components of embodiments described herein are implemented using one or more computers, such as example computer 700 shown in FIG. 7. Computer 700 can be any commercially available and well known computer capable of performing the functions described herein, such as computers available from International Business Machines, Apple, Oracle, HP, Dell, Cray, etc.

Computer 700 includes one or more processors (also called central processing units, or CPUs), such as a processor 706. Processor 706 is connected to a communication infrastructure 704.

Computer 700 also includes a main or primary memory 708, such as random access memory (RAM). Primary memory 708 has stored therein control logic 768A (computer software), and data.

Computer 700 also includes one or more secondary storage devices 710. Secondary storage devices 710 include, for example, a hard disk drive 712 and/or a removable storage device or drive 714, as well as other types of storage devices, such as memory cards and memory sticks. Removable storage drive 714 represents a floppy disk drive, a magnetic tape drive, a compact disk drive, an optical storage device, tape backup, etc.

Removable storage drive 714 interacts with a removable storage unit 716. Removable storage unit 716 includes a computer useable or readable storage medium 764A having stored therein computer software 768B (control logic) and/or data. Removable storage unit 716 represents a floppy disk, magnetic tape, compact disk, DVD, optical storage disk, or any other computer data storage device. Removable storage drive 714 reads from and/or writes to removable storage unit 716 in a well-known manner.

Computer 700 also includes input/output/display devices 766, such as monitors, keyboards, pointing devices, Bluetooth devices, etc.

Computer 700 further includes a communication or network interface 718. Network interface 718 enables computer 700 to communicate with remote devices. For example, network interface 718 allows computer 700 to communicate over communication networks or mediums 764B (representing a form of a computer useable or readable medium), such as LANs, WANs, the Internet, etc. Network interface 718 may interface with remote sites or networks via wired or wireless connections.

Control logic 768C may be transmitted to and from computer 700 via communication medium 764B.

Any tangible apparatus or article of manufacture comprising a computer useable or readable medium having control logic (software) stored therein is referred to herein as a computer program product or program storage device. This includes, but is not limited to, computer 700, main memory 708, secondary storage devices 710 and removable storage unit 716. Such computer program products, having control logic stored therein that, when executed by one or more data processing devices, cause such data processing devices to operate as described herein, represent the embodiments.

Embodiments can work with software, hardware, and/or operating system implementations other than those described herein. Any software, hardware, and operating system implementations suitable for performing the functions described herein can be used. Embodiments are applicable to both a client and to a server or a combination of both.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

1. A computer implemented method performed by a mobile device, comprising:
receiving from a user a length and width of an environment;
receiving a series of photographs taken front different positions in the environment by the user with a camera on a mobile device;
deriving a three-dimensional model of the environment based on the photographs, length and width;
detecting, using a sensor on the mobile device, an identifier identifying a physical object wherein the identifier and the environment are not co-located;
retrieving, using the detected identifier, a three-dimensional model of the physical object that is capable of being placed within a three-dimensional model of an environment;
displaying, on a display of the mobile device, the three-dimensional model of the physical object within the three-dimensional model of the environment; and
in response to user gestures on the display of the mobile device, displaying the three-dimensional model of the physical object at different places within the three-dimensional model of the environment.

2. The method of claim 1 wherein receiving a three-dimensional model of an environment comprises:
receiving from the user the length and width of the environment;
receiving a series of photographs taken from different positions in the environment; and
deriving a three-dimensional model of the environment based on the photographs, length and width.

3. The method of claim 2 wherein deriving a three-dimensional model comprises:
identifying features on the photographs;
matching features on adjacent photographs;
deriving a surface model for the point cloud; and
texture mapping the photographs to the surface model.

4. The method of claim 1 wherein detecting comprises:
capturing, using a camera on the mobile device, an image of a barcode for the physical object; and
scanning the image to detect an identifier identifying the physical object on a server having a three-dimensional model of the physical object, the scanning performed by an application on the mobile device.

5. The method of claim 4, wherein the scanning comprises scanning the image to detect a Uniform Resource Locator (URL) addressing the server, and wherein the retrieving comprises:
connecting to the server using the URL, the server having a three-dimensional model of the physical object;
sending, via the connection, the identifier to the server; and
downloading, from the server, the three-dimensional model of the physical object.

6. The method of claim 1 wherein displaying the physical object at different places within the environment comprises:
in response to the user touching and dragging a representation of the physical object on the display, moving the physical object within the environment.

7. The method of claim 1 wherein displaying the physical object at different places within the environment comprises:
in response to the user touching and making horizontal gestures with the mobile device, panning the physical object within the environment.

8. The method of claim 1 wherein displaying the physical object at different places within the environment comprises:
in response to the user touching either side of the display of the mobile device, panning the physical object within the environment.

9. The method of claim 1 wherein displaying the physical object comprises:
enabling a user to select a set of color choices for the physical object; and
displaying the physical object in a particular color specified by the user's selection.

10. A computer-based system, comprising:
one or more processors;
an environment virtualizer configured to receive from a user a length and width of an environment, receive a series of photographs taken from different positions in the environment by the user with a camera on a mobile device, and derive a three-dimensional model of the environment based on the photographs, length and width;
a QR barcode application configured to detect, using a sensor on the mobile device, an identifier identifying a physical object when the identifier and the environment are not co-located;
a physical object placer configured to retrieve, using the detected identifier, a three-dimensional model of the physical object that is capable of being placed within a three-dimensional model of an environment, to display, on a display of the mobile device, the three-dimensional model of the physical object within the three-dimensional model of the environment, and in response to user gestures on the display of the mobile device, to display the three-dimensional model of the physical object at different places within the three-dimensional model of the environment.

11. The system of claim 10 wherein the environment virtualizer is further configured to receive from the user the length and width of the environment, to receive a series of photographs taken from different positions in the environment, and to derive a three-dimensional model of the environment based on the photographs, length and width.

12. The system of claim 11 wherein the environment virtualizer is further configured to identify features on the photographs, to match features on adjacent photographs, to derive a surface model for the point cloud, and to texture map the photographs to the surface model.

13. The system of claim 10 wherein the QR application is configured to capture, using a camera on the mobile device, an image of a barcode for the physical object, and to scan the image to detect an identifier identifying the physical object, the scanning performed by an application on the mobile device.

14. The system of claim 13 wherein the QR application is configured to scan the image to detect a Uniform Resource Locator (URL) addressing the server, and wherein the physical object placer is configured to connect to the server using the URL, the server having a three-dimensional model, of the physical object, to send, via the connection, the identifier to the server, and to download, from the server, the three-dimensional model of the physical object.

15. The system of claim 10 wherein the physical object placer is configured to, in response to the user touching and dragging the physical object on the display, move the physical object within the environment.

16. The system of claim 10 wherein the physical object placer is configured to, in response to the user touching and making horizontal gestures with the mobile device, pan the physical object within the environment.

17. The system of claim 10 wherein the physical object placer is configured to, in response to the user touching either side of the display of the mobile device, pan the physical object within the environment.

18. The system of claim 10 wherein the physical object placer is configured to enable a user to select a set of color choices for the physical object and display the physical object in a particular color specified by the user's selection.

19. A non-transitory computer storage apparatus encoded with a computer program, the program comprising instructions that when executed by data processing apparatus cause the data processing apparatus to perform operations comprising:
receiving from the user a length and width of an environment;
receiving a series of photographs taken from different positions in the environment by the user with a camera on a mobile device;
deriving a three dimensional model of the Environment based on the photographs, length and width;
detecting, using a sensor on the mobile device, an identifier identifying a physical object, wherein the identifier and the environment are not co-located;
retrieving, using the detected identifier, a three-dimensional model of the physical object that is capable of being placed within a three-dimensional model of an environment;
displaying, on a display of the mobile device, the three-dimensional model of the physical object within the three-dimensional model of the environment; and
in response to user gestures on the display of the mobile device, displaying the three-dimensional model of the physical object at different places within the three-dimensional model of the environment.

20. The computer storage apparatus of claim 19, the operations further comprising:
receiving from the user the length and width of the environment;
receiving a series of photographs taken from different positions in the environment; and
deriving a three-dimensional model of the environment based on the photographs, length and width.

21. The computer storage apparatus of claim 20, the operations further comprising:
identifying features on the photographs;
matching features on adjacent photographs;
deriving a surface model for the point cloud; and
texture mapping the photographs to the surface model.

22. The computer storage apparatus of claim 19, the operations further comprising:
capturing, using a camera on the mobile device, an image of a barcode for the physical object; and
scanning the image to detect an identifier identifying the physical object on a server having a three-dimensional model of the physical object, the scanning performed by an application on the mobile device.

23. The computer storage apparatus of claim 22, wherein the scanning comprises scanning the image to detect a Uniform Resource Locator (URL) addressing the server, and wherein the retrieving comprises:
connecting to the server using the URL, the server having a three-dimensional model of the physical object;
sending, via the connection, the identifier to the server; and
downloading, from the server, the three-dimensional model of the physical object.

24. The computer storage apparatus of claim 19, the operations further comprising:
in response to the user touching and dragging a representation of the physical object on the display, moving the physical object within the environment.

25. The computer storage apparatus of claim 19, the operations further comprising:
in response to the user touching and making horizontal gestures with the mobile device, panning the physical object within the environment.

26. The computer storage apparatus of claim 19, the operations further comprising:
in response to the user touching either side of the display of the mobile device, panning the physical object within the environment.

27. The computer storage apparatus of claim 19, the operations further comprising:
enabling a user to select a set of color choices for the physical object; and
displaying the physical object in a particular color specified by the user's selection.
